(19) United States
(12) Patent Application Publication
(10) Pub. No.: US 2024/0083592 A1
(43) Pub. Date: Mar. 14, 2024

(54) Electronic device for storing a terrain database, method for generating such a database, related avionics system, monitoring method and computer programs

(71) Applicant: THALES, COURBEVOIE (FR)

(72) Inventors: Denis RICAUD, MERIGNAC (FR); Pierre-Yves DUMAS, MERIGNAC (FR)

(21) Appl. No.: 18/260,986

(22) PCT Filed: Jan. 12, 2022
(86) PCT No.: PCT/EP2022/050494

§ 371 Date: Jul. 11, 2023

(30) Foreign Application Priority Data
Jan. 12, 2021 (FR) 21 00243

(51) Int. Cl. B64D 45/00; G06F 16/29

(52) U.S. Cl. CPC B64D 45/00; G06F 16/29

(57) ABSTRACT

This electronic device for storing a terrain database for an avionics system is carried on board an aircraft. The terrain database corresponds to a terrain zone likely to be overflown by the aircraft, represented in the form of a surface area divided into meshes, each mesh corresponding to a sector of the terrain zone, the terrain database having a first resolution and comprising first terrain elevation values, each associated with a respective mesh. The terrain database further comprises, for each mesh, an uncertainty value associated with the respective first elevation value, at least one uncertainty value being calculated from a plurality of second terrain elevation values associated with said mesh and from a second terrain database having a second resolution higher than the first resolution.

### CROSS-REFERENCE TO RELATED APPLICATIONS

This application is the U.S. national phase of International Application No. PCT/EP2022/050494 filed 12 Jan. 2022, which designated the U.S. and claims priority to French Patent Application No. 21 00243 filed 12 Jan. 2021, the entire contents of each of which are hereby incorporated by reference.

### FIELD

The present invention relates to an electronic device for storing a terrain database for an avionics system, the storage device being configured to be carried on board an aircraft, the terrain database corresponding to a terrain zone likely to be overflown by the aircraft, represented in the form of a surface divided into meshes, each mesh corresponding to a sector of the terrain zone.

The invention also relates to an avionics system configured to be carried on board an aircraft, comprising or being connected to such an electronic storage device.

The invention also relates to a generating method of generating a terrain database for an avionics system, the generating method being implemented by computer.

The invention also relates to a non-transitory computer-readable medium including a computer program including software instructions which, when executed by a computer, implement such a generating method.

The invention also relates to a monitoring method of monitoring a vertical positioning of an aircraft, the method being implemented by an electronic monitoring device configured to be carried on board the aircraft and connected to such an electronic storage device.

The invention also relates to a non-transitory computer-readable medium including a computer program including software instructions which, when executed by a computer, implement such a monitoring method.

### BACKGROUND

The invention relates to the field of terrain databases for avionics systems and avionics systems, such as aircraft guidance and monitoring systems using such terrain databases. These systems are typically based on navigation sensors, such as a satellite geolocation sensor, also called Global Navigation Satellite System (GNSS) sensor, a radio altimeter or a pressure sensor allowing to measure the barometric altitude; and generally, propose a human-machine interface presenting to the pilot all the information required for the guidance of the aircraft.

The advent of so called Synthetic Vision Systems (SVS) in civil aircraft allows to increase the safety of operations by presenting the crew with a permanent three-dimensional synthetic image of their environment. This image is calculated from the position and altitude of the aircraft, as well as from terrain information from a terrain database carried on board the aircraft.

Other monitoring systems, such as a Terrain Awareness and Warning System (TAWS), use the terrain database to alert the pilot if the trajectory of the aircraft is about to enter into conflict with the terrain.

However, the algorithms and terrain databases used make them generally relatively insensitive to a single error.

### SUMMARY

The purpose of the invention is then to propose an electronic device for storing a terrain database for an avionics system, configured to be carried on board an aircraft and allowing to offer a more reliable terrain database, in order to reduce the risks of an aircraft accident.

To this end, the invention concerns an electronic storage device for storing a terrain database for an avionics system, the storage device being configured to be carried on board an aircraft, the terrain database corresponding to a terrain zone likely to be overflown by the aircraft, represented as a surface divided into meshes, each mesh corresponding to a sector of the terrain zone, the terrain database having a first resolution and comprising first terrain elevation values, each being associated with a respective mesh, the terrain database further comprising, for each mesh, an uncertainty value associated with the respective first elevation value, at least one uncertainty value being calculated from a plurality of second terrain elevation values associated with said mesh and from a second terrain database having a second resolution, the second resolution being higher than the first resolution.

Thus, with the electronic storage device according to the invention, the terrain database intended to be carried on board the aircraft, also referred to as the first terrain database, further comprises for each elevation value of a sector of the terrain area, an uncertainty value associated with the respective elevation value, the uncertainty value then allowing to know the reliability of this elevation value.

Furthermore, at least one uncertainty value is calculated from the plurality of second elevation values from the second, higher resolution database, which allows to have an uncertainty value calculated in even more reliable ways. The person skilled in the art will indeed understand that the second terrain database presenting a higher resolution than the first terrain database, each mesh of the first database corresponds to a plurality of meshes of the second database, the second elevation values being each associated with a respective mesh of the second database.

In other words, the said at least one uncertainty value is calculated from the elevation values of a plurality of sub-meshes of the respective mesh of the first database, each sub-mesh corresponding to a respective mesh of the second database.

Because its second resolution is higher than the first resolution of the first database, the second terrain database includes a larger amount of information than the first database and therefore requires more storage space. The second terrain database is then typically stored in an electronic equipment external to the storage device, this external equipment being preferably arranged outside the aircraft, and for example installed on the ground.

According to other advantageous aspects of the invention, the electronic storage device comprises one or more of the following features, taken alone or in any technically possible combination:
the second terrain database is stored in an electronic equipment external to the electronic storage device,
the external equipment preferably being arranged outside the aircraft;
the at least one uncertainty value is selected for each mesh from among the group consisting of: a difference between a maximum value and a minimum value among the plurality of second elevation values associated with the respective mesh; and a standard deviation of the second elevation values associated with the respective mesh relative to said maximum value;
each uncertainty value preferably being calculated from said plurality of second elevation values associated with the respective mesh;
at least one first elevation value is determined from the plurality of second elevation values associated with the respective mesh;
at least one first elevation value preferably being selected from among the group consisting of: a maximum value of the second elevation values associated with the respective mesh; a mean value of the second elevation values associated with the respective mesh; and the maximum value of the second elevation values minus N times a standard deviation of the second elevation values associated with the respective mesh relative to said maximum value, N being an integer greater than or equal to 1;
each first elevation value preferably being further determined from the second elevation values associated with the respective mesh; and
the first and second resolutions are expressed in arc-second(s), the arc-second value of each resolution defining the dimension corresponding to a side of a smallest representative feature of the terrain, a higher resolution corresponding to a lower arc-second value;
the first resolution being preferably equal to 3 or 6 arc-seconds;
the second resolution being preferably still equal to 1 or 2 arc-seconds.

The invention also relates to an avionics system configured to be carried on board an aircraft, the avionics system comprising or being connected to an electronic device for storing a terrain database, the electronic storage device being as defined above, and the avionics system comprising an electronic monitoring device configured to monitor an altitude of the aircraft via a comparison between, on the one hand, an altitude from an altitude sensor, such as a satellite geolocation sensor or a pressure sensor, and on the other hand, the sum of a first terrain elevation value from the terrain database and a height above ground from a radio altimeter, the comparison depending on the uncertainty value associated with the respective first elevation value.

Thus, the avionics system according to the invention allows, through its electronic monitoring device, to monitor the reliability of the terrain database intended to be carried on board the aircraft and/or the reliability of the radio altimeter and/or the altitude sensor, such as the satellite geolocation sensor and/or the pressure sensor.

Indeed, the constant evolution of human infrastructures modifies the real elevation of the terrain, with for example the construction of new buildings, the leveling of mountains or quarries, and quickly makes a terrain database less reliable, even relatively obsolete. The monitoring of the accuracy of the terrain database, and if necessary, the generation of an alert to the pilot or the database provider, is therefore of great interest.

On the other hand, the radio altimeter continuously provides a height above the ground, in other words, a height above ground, and the sum of this height and the terrain elevation provided by the terrain database is then compared with the altitude from the altitude sensor, which also allows to monitor the operation of the radio altimeter and/or the altitude sensor, and to generate an alert if necessary.

This further allows to improve the safety of the aircraft, as radio altimeter failures have been the cause of aircraft incidents in the past. Furthermore, the fact that the radio altimeter of the aircraft can be monitored is also interesting in a context of increasing electromagnetic disturbances, linked for example to the arrival of base stations compliant with the 5G standard and which can interfere, under certain conditions, in the frequency band between 4.2 and 4.4 GHz corresponding to the typical frequency band of a radio altimeter.

The invention also concerns a generating method for generating a terrain database for an avionics system, intended to be stored in an electronic storage device configured to be carried on board an aircraft, the terrain database corresponding to a terrain zone likely to be overflown by the aircraft, represented as a surface divided into meshes, each mesh corresponding to a sector of the terrain zone, the terrain database comprising a first resolution and comprising first terrain elevation values, each being associated with a respective mesh
the method being computer-implemented and comprising the following steps:
calculating, for each mesh, an uncertainty value associated with the respective first elevation value, at least one uncertainty value being calculated from a plurality of second terrain elevation values associated with said mesh and from a second terrain database having a second resolution, the second resolution being higher than the first resolution;
including each calculated uncertainty value in the terrain database.

The invention also relates to a non-transitory computer-readable medium including a computer program including the software instructions which, when executed by a computer, implement a generating method as defined above.

The invention also concerns a monitoring method for monitoring the vertical positioning of an aircraft, the method being implemented by an electronic monitoring device configured to be carried on board the aircraft and connected to an electronic device for storing a terrain database,
the method comprising the comparison between, on the one hand, an altitude from an altitude sensor, such as a satellite geolocation sensor or a pressure sensor, and, on the other hand, the sum of a first terrain elevation value from the terrain database and a height above ground from a radio altimeter, the comparison being dependent on the uncertainty value associated with the respective first elevation value, the terrain database having been generated via a generating method as defined above.

According to another advantageous aspect of the invention, the monitoring method further comprises generating an alert in case an error is determined during said comparison, the generated alert being a function of the determined error and being selected from among the group consisting of: an alert relating to the terrain database, an alert relating to the altitude sensor, an alert relating to the radio altimeter, an alert relating to both the altitude sensor and the radio altimeter, and a global alert.

The invention also relates to a non-transitory computer-readable medium including a computer program including the software instructions which, when executed by a computer, implement a monitoring method as defined above.

### BRIEF DESCRIPTION OF THE DRAWINGS

These features and advantages of the invention will become clearer upon reading the following description, given only as a non-limiting example, and made with reference to the appended drawings, in which:

FIG. 1 is a schematic representation of an aircraft comprising an electronic device for storing a terrain database, an avionics system including an electronic device for monitoring the vertical positioning of the aircraft, an altitude sensor and a radio altimeter;

FIG. 2 is a schematic view representing data contained in the terrain database of FIG. 1, an altitude from the altitude sensor of FIG. 1, as well as a sum of a terrain elevation value from said database and a height above ground from the radio altimeter of FIG. 1;

FIG. 3 is a flowchart of a method according to the invention for generating the terrain database intended to be stored in the storage device of FIG. 1; and

FIG. 4 is a flowchart of a method according to the invention for monitoring a vertical positioning of the aircraft, the method being implemented by the electronic monitoring device of FIG. 1.

### DETAILED DESCRIPTION

In the remainder of the description, the term “substantially equal to” defines a relationship of equality to plus or minus 10%, preferably plus or minus 5%.

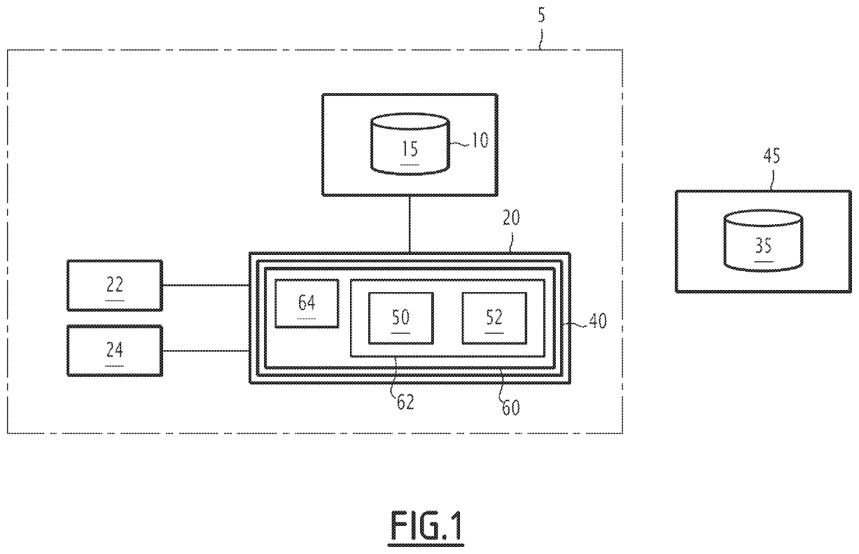

In FIG. 1, an aircraft 5 comprises an electronic device 10 for storing a terrain database 15, an avionics system 20, an altitude sensor 22 and a radio altimeter 24.

The aircraft 5 is, for example, an airplane. Alternatively, the aircraft 5 is a helicopter, a vertical take-off and landing aircraft, also called ADAV or VTOL (Vertical Take-Off and Landing), or a drone that can be flown remotely by a pilot.

The electronic storage device 10 is configured to be carried on board the aircraft 5. The storage device 10 comprises the terrain database 15 able to be used by the avionics system 20.

The storage device 10 is, for example, in the form of a computer memory, or a hard drive.

In the example of FIG. 1, the storage device 10 is distinct from the avionics system 20 and is then connected to the avionics system 20 so that the avionics system 20 can use the terrain database 15 contained in the storage device 10.

In an alternative not shown, the storage device 10 is integrated into the avionics system 20.

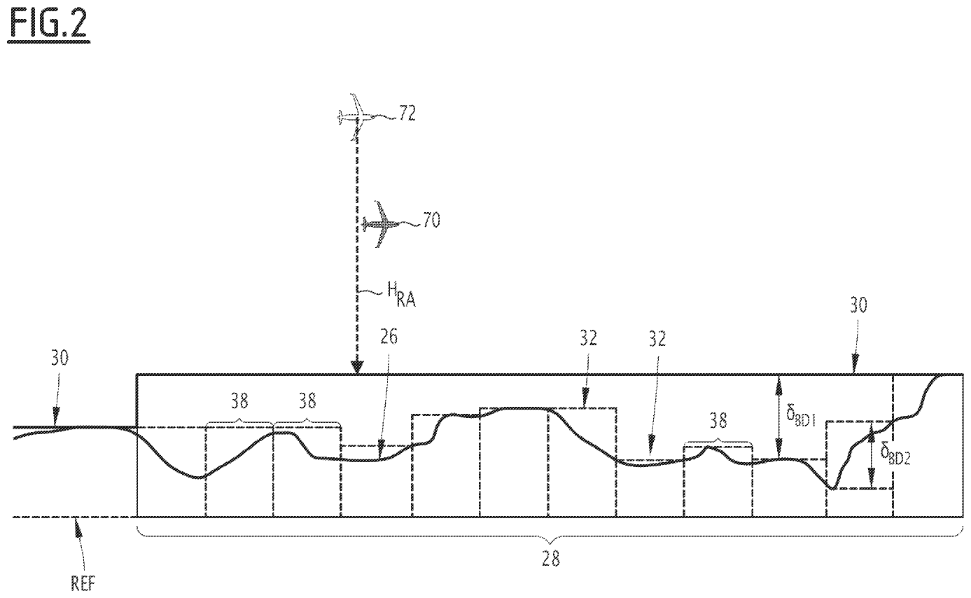

The terrain database 15, also referred to as the first database 15 hereinafter, corresponds to a terrain zone 26 likely to be overflown by the aircraft 5, shown as a surface partitioned into meshes 28, each mesh 28 corresponding to a sector of the terrain zone 26 and also being referred to as the first mesh 28 hereinafter, as shown in FIG. 2.

The terrain database 15 has a first resolution R1 and comprises elevation values 30, each associated with a respective mesh 28 and also being referred to as a first elevation value 30 hereafter. Each first elevation value 30 is a reference value of a height above ground 26 within the respective first mesh 28 and relative to a reference elevation REF, typically Mean Sea Level, also noted as MSL.

The terrain database 15 typically comprises a single first elevation value 30 for each respective first mesh 28.

According to the invention, the terrain database 15 further includes, for each respective first mesh 28, an uncertainty value δ_{BD1} associated with the respective first elevation value 30, also referred to as the first uncertainty value δ_{BD1} hereafter.

At least one first uncertainty value δ_{BD1} is calculated from a plurality of second elevation values 32 corresponding to said first mesh 28 and from a second terrain database 35 having a second resolution R2, the second resolution R2 being higher than the first resolution R1.

Because the second terrain database 35 presenting a higher resolution than the first terrain database 15, each first mesh 28 of the first database 15 corresponds to a plurality of meshes 38 of the second database 35, also referred to as second meshes 38 hereafter and visible in FIG. 2. The second meshes 38 corresponding to a respective first mesh 28 then form sub-meshes of that respective first mesh 28. The second elevation values 32 are each associated with a respective mesh 38 of the second database 35.

Each second elevation value 32 is a reference value of a height of terrain 26 within the respective second mesh 38 and relative to the reference elevation REF. Each second elevation value 32 corresponds, for example, to the maximum height above ground 26 relative to the reference elevation REF, this within the respective second mesh 38; in other words, the height, relative to this reference elevation REF, of the highest point above ground 26 within this respective second mesh 38.

The first resolution R1 and the second resolution R2 are each, for example, expressed in arc-second(s), denoted arcsec, with the arc-second resolution value then defining the dimension corresponding to a side of a smaller representative element. The person skilled in the art will then understand that the lower the resolution, the higher its value expressed in arcsec.

The first resolution R1 is for example equal to 3 or 6 arcsec, and the second resolution R2 is for example equal to 1 or 2 arcsec.

The skilled person will then understand that said at least one uncertainty value δ_{BD1} is calculated from the elevation values 32 of a plurality of sub-meshes of the respective mesh 28 of the first database 15, each sub-mesh corresponding to a respective second mesh 38 of the second database 35.

Each first uncertainty value δ_{BD1} is preferably calculated from the plurality of second elevation values 32 corresponding to the respective first mesh 28 of the first database 15.

Each first uncertainty value δ_{BD1} that is calculated from the plurality of second elevation values 32 is for example selected from among the group consisting of:
a difference between a maximum value and a minimum value among the plurality of second elevation values 32 associated with the respective first mesh 28; and
a standard deviation of the second elevation values 32 associated with the respective first mesh 28 relative to said maximum value.

In the example of FIG. 2, the first uncertainty value δ_{BD1} is equal to the difference between the maximum value and the minimum value from among the plurality of second elevation values 32 associated with the respective first mesh 28. In other words, in this example, the first uncertainty value δ_{BD1} is equal to the difference between the maximum value of the second elevation values 32 associated with the respective first mesh 28 and the minimum value of said second elevation values 32.

As an optional addition, at least one first elevation value 30 is determined from the plurality of second elevation values 32 corresponding to the respective first mesh 28. According to this optional addition, each first elevation value 30 is preferably determined from said plurality of second elevation values 32 corresponding to the respective first mesh 28.

Each first elevation value 30 that is determined from the plurality of second elevation values 32 associated with the respective first mesh 28 is for example selected from the group consisting of:
a maximum value of the second elevation values 32 associated with the respective first mesh 28;
an average value of the second elevation values 32 associated with the respective first mesh 28; and
the maximum value of the second elevation values 32 minus N times a standard deviation of the second elevation values 32 associated with the respective first mesh 28 relative to said maximum value, N being an integer greater than or equal to 1.

In the example of FIG. 2, the first elevation value 30 is equal to the maximum value of the second elevation values 32 corresponding to the respective first mesh 28.

As an optional addition, the terrain database 15 further comprises, for each first mesh 28, an uncertainty value δ_{BD2} dependent only on the data contained in the second database 35, also referred to as the second uncertainty value δ_{BD2} hereafter.

Each second uncertainty value δ_{BD2} is, for example, calculated from a plurality of height deviations, each height deviation, also referred to as an elevation deviation, being associated with a respective second mesh 38 and corresponding to the difference between a maximum elevation and a minimum elevation of the terrain 26 within said second mesh 38. Each second uncertainty value δ_{BD2} is, for example, equal, for a respective first mesh 28 of the first database 15, to the maximum value from among the plurality of elevation deviations for the different second meshes 38 of the second database 35 corresponding to said first mesh 28 of the first database 15, as shown in FIG. 2.

Each second uncertainty value δ_{BD2} is less than each first uncertainty value δ_{BD1} for a respective first mesh 28, given that the second resolution R2 is higher than the first resolution R1, with a ratio typically equal to 3 between the values of the first and second resolutions R1, R2 expressed in arcsec.

Each second uncertainty value δ_{BD2} is then, for example, increased by a predefined constant, said constant typically depending on the second resolution R2 of the second database 35.

The avionics system 20 is configured to be carried on board the aircraft 5, and is connected to the electronic storage device 10, as shown in FIG. 1.

In an alternative, not shown, the avionics system 20 comprises the electronic storage device 10.

The avionics system 20 is for example selected from among the group consisting of:
an aircraft flight management system, also referred to as Flight Management System (FMS);
a Terrain Awareness and Warning System (TAWS);
a navigation information display system, also called Navigation Display (ND); and
a primary flight display, (PFD), with or without a synthetic vision system, (SVS).

The avionics system 20 comprises an electronic device 40 for monitoring a vertical positioning of the aircraft 5.

The altitude sensor 22 is known per se, and is for example a satellite geolocation sensor, also called a Global Navigation Satellite System (GNSS), such as a Global Positioning System sensor (GPS), a GLONASS sensor, a Galileo sensor; or a pressure sensor for measuring a barometric altitude, such as an anemobarometric sensor.

The radio altimeter 24 is known per se.

The second terrain database 35 is stored in an electronic equipment 45 external to the electronic storage device 10. The electronic equipment 45 in which the second terrain database 35 is stored is preferably arranged outside the aircraft 5.

The electronic monitoring device 40 is configured to monitor the altitude of the aircraft 5.

The monitoring device 40 comprises a module 50 for comparing an altitude ALT_{MSL} from the altitude sensor 22 with the sum of a first elevation value 30 and a height above ground H_{RA} from the radio altimeter 24.

As an optional addition, the monitoring device 40 comprises a module 52 for generating an alert if an error is detected by the comparison module 50.

In the example of FIG. 1, the electronic monitoring device 40 comprises an information processing unit 60 formed by, for example, a memory 62 and a processor 64 associated with the memory 62.

In the example of FIG. 1, the comparison module 50, as well as an optional addition the generation module 52, are each realized as a software program, or software brick, executable by the processor 64. The memory 62 of the electronic monitoring device 40 is then able to store software for comparing the altitude ALT_{MSL} from the altitude sensor 22 with the sum of the first elevation value 30 and the height above ground H_{RA} from the radio altimeter 24. As an optional addition, the memory 62 of the electronic monitoring device 40 is also able to store software for generating the alert in the event that a respective error is detected by the comparison software. The processor 64 is then able to execute the comparison software, as well as an optional addition, the generation software.

In an alternative, not shown, the comparison module 50, as well as an optional addition, the generation module 52, are each realized as a programmable logic component, such as a Field Programmable Gate Array (FPGA), or as a dedicated integrated circuit, such as an Application Specific Integrated Circuit (ASIC).

When the electronic monitoring device 40 is realized as one or more software programs, in other words, as a computer program, it is furthermore able to be recorded on a computer-readable medium, not shown. The computer-readable medium is, for example, a medium able to store electronic instructions and of being coupled to a bus of a computer system. For example, the readable medium is an optical disk, a magneto-optical disk, a ROM memory, a RAM memory, any type of non-volatile memory (for example, EPROM, EEPROM, FLASH, NVRAM), a magnetic card or an optical card. On the readable medium is then stored a computer program comprising software instructions.

The comparison module 50 is configured to compare, on the one hand, the altitude ALT_{MSL} from the altitude sensor 22, represented by a first symbol 70 in the shape of an aircraft in FIG. 2, and, on the other hand, the sum of the corresponding first terrain elevation value 30, from the terrain database 15, and the height above ground H_{RA} from the radio altimeter 24, this sum being represented in FIG. 2 by a second symbol 72 also in the shape of an aircraft.

The comparison module 50 is preferably configured to carry out the comparison of the altitude ALT_{MSL} from the altitude sensor 22 with the sum of the respective first elevation value 30 and the height above ground H_{RA}, further depending on the first uncertainty value δ_{BD1} associated with said first elevation value 30.

For example, the comparison module 50 is configured to carry out this comparison according to the following equation:

ALT_{MSL}+δ_{MSL}=H_{RA}+δ_{RA}+ELV_{BD1}+δ_{BD1} [[1]
Where ALT_{MSL} represents the altitude from the altitude sensor 22,
δ_{MSL} represents an uncertainty value associated with the altitude ALT_{MSL} from the altitude sensor 22,
H_{RA} represents the height above ground from the radio altimeter 24,
δ_{RA} represents an uncertainty value associated with the height above ground H_{RA} from the radio altimeter 24,
ELV_{BD1} represents the respective first elevation value 30 from the first terrain database 15, and
δ_{BD1} represents the first uncertainty value associated with said first elevation value ELV_{BD1}.

The uncertainty value δ_{MSL} associated with the altitude ALT_{MSL} from the altitude sensor 22 corresponds, for example, to an information given by the parameter Vertical Figure Of Merit (VFOM) when the elevation sensor 22 is a GPS sensor offering an elevation corrected by a spatial augmentation system, such as a Satellite-Based Augmentation System (SBAS) corrected altitude. Alternatively, the uncertainty value δ_{MSL} associated with the altitude ALT_{MSL} is a predefined value, such as an uncertainty value substantially equal to 56 ft (from English feet) corresponding to a deviation of 2 hPa in the lowest layers of the atmosphere, when the altitude sensor 22 is a pressure sensor. In another alternative, the uncertainty value δ_{MSL} associated with the altitude ALT_{MSL} is a value depending in particular on the distance between the aircraft 5 and an airport transmitting a baro corrected altitude, called QNH altitude, when the altitude sensor 22 is a pressure sensor.

The uncertainty value δ_{RA} associated with the height above ground H_{RA} from the radio altimeter 24 is, for example, indicated in a table of accuracy of the radio altimeter 24, such as the first table shown below as an example.

TABLE 1

| | Vertical velocity | |
|---|---|---|
| Altitude (ft) | (ft/s) | δ_{RA} |
| −20 to 75 | 0 to 20 | ±1.5 ft |
| 75 to 2500 | 0 to 25 | ±2% |
| 2500 to 5000 | 0 to 25 | ±3% |

As an optional addition, the comparison module 50 is configured to perform the comparison between the altitude ALT_{MSL} from the altitude sensor 22 and the sum of the first elevation value 30 and the height above ground H_{RA}, as a function of the second uncertainty value δ_{BD2} associated with said first elevation value 30.

According to this optional addition, the comparison module 50 is for example configured to perform this comparison according to the following equation:

ALT_{MSL}+δ_{MSL}=H_{RA}+δ_{RA}+ELV_{BD1}+δ_{BD1}+δ_{BD2} [[2]
where δ_{BD2} further represents the second uncertainty value associated with the first elevation value ELV_{BD1}.

As yet another further optional addition, the comparison module 50 is configured to calculate a quadratic sum of uncertainty values, denoted Δₘₐₓ, equal to the quadratic sum of the uncertainty value δ_{MSL} associated with the altitude ALT_{MSL}, the uncertainty value δ_{RA} associated with the height above ground H_{RA}, and the first uncertainty value δ_{BD1} for the respective first mesh 28; and if need be, in addition, the second uncertainty value δ_{BD2} for said first mesh 28.

According to this optional addition, the comparison module 50 is then configured to compare, relative to the quadratic sum Δₘₐₓ of the uncertainty values, the difference in absolute value between the sum of the first elevation value 30, also denoted ELV_{BD1}, and the height above ground H_{RA} on the one hand, and the altitude ALT_{MSL} from the altitude sensor 22 on the other hand. The comparison module 50 is then configured to detect an absence of error relating to the altitude of the aircraft 5 if this difference in absolute value is less than or equal to said quadratic sum Δₘₐₓ, in other words, if the inequation (3) below is satisfied, and conversely to detect the presence of an error if this difference in absolute value is greater than said quadratic sum Δₘₐₓ, in other words, if the inequation (4) below is satisfied.

|H_{RA}+ELV_{BD1}−ALT_{MSL}|≤Δₘₐₓ [[3]
where |·| represents the absolute value, and
Δₘₐₓ represents the quadratic sum of the uncertainty values.

|H_{RA}+ELV_{BD1}−ALT_{MSL}|>Δₘₐₓ [[4]

In case of detection of the presence of an error if the inequation (4) is satisfied, the comparison module 50 is further configured to determine that the error is associated with the first terrain database 15 if the altitude ALT_{MSL} from the altitude sensor 22 is an SBAS corrected altitude or a QNH-corrected baro corrected altitude, and if the inequation (4) is satisfied for a period of time between a first predefined time T1 and a second predefined time T2.

The first predefined time T1 corresponds, for example, to a time allowing the aircraft 5 to fly over at least two first meshes 28 in their diagonal. When the aircraft 5 is an airplane, the first predefined time T1 is for example equal to 10 seconds for a first resolution R1 equal to 6 arcsec and a speed of the aircraft 5 substantially equal to 100 kts (knots).

The second predefined time T2 corresponds for example to a time allowing the aircraft 5 to fly over at least twelve first meshes 28 in their diagonal, and then for example equal to six times the first predefined time T1.

In addition, if the inequation (4) is satisfied for a time greater than the second predefined time T2 and if the integrity of the position of the aircraft 5 from the altitude sensor 22, also noted HPL and in the case where the altitude sensor 22 is a satellite geolocation sensor, is less than or equal to a predefined threshold HPL_{HQ}, the comparison module 50 is then configured to determine that the error is associated with the altitude sensor 22 if the aircraft 5 is equipped with two distinct radio altimeters 24 and if the heights relative to the ground from these two distinct radio altimeters 24 are consistent; and to determine that the error is associated with the radio altimeter 24 if the heights relative to the ground from these two separate radio altimeters 24 are inconsistent.

As a further addition, if the inequation (4) is satisfied during a period of time greater than the second predefined period of time T2, if the positioning integrity HPL is less than or equal to the predefined threshold HPL_{HQ}, but the aircraft 5 is equipped with a single radio altimeter 24, then the comparison module 50 is configured to determine that the error is associated with the altitude sensor 22 and/or the radio altimeter 24.

As a further addition, if the inequation (4) is satisfied for a period of time greater than the second predefined period of time T2 and the positioning integrity HPL is greater than the predefined threshold HPL_{HQ}, the comparison module 50 is configured to detect an inconsistency between the first terrain database 15 and the position provided by the altitude sensor 22, and to then suspend the altitude monitoring of the aircraft 5 for a predefined time delay.

As an optional addition, the generation module 52 is configured to generate an alert upon determination of an error by the comparison module 50.

For example, the generation module 52 is configured to generate an alert relating to the terrain database 15 if the comparison module 50 has previously determined that the error is associated with the first terrain database 15; to generate an alert relating to the altitude sensor 22 if the comparison module 50 has previously determined that the error is associated with said altitude sensor 22; to generate an alert relating to the radio altimeter 24 if the comparison module 50 has previously determined that the error is associated with said radio altimeter 24; to generate an alert relative to the altitude sensor 22 and the radio altimeter 24 if the comparison module 50 has previously determined that the error is associated with the altitude sensor 22 and/or the radio altimeter 24; and to generate a global alert if the comparison module 50 has previously detected an inconsistency between the first terrain database 15 and the position provided by the altitude sensor 22 and then suspends the monitoring of the altitude of the aircraft 5 for the predefined time delay.

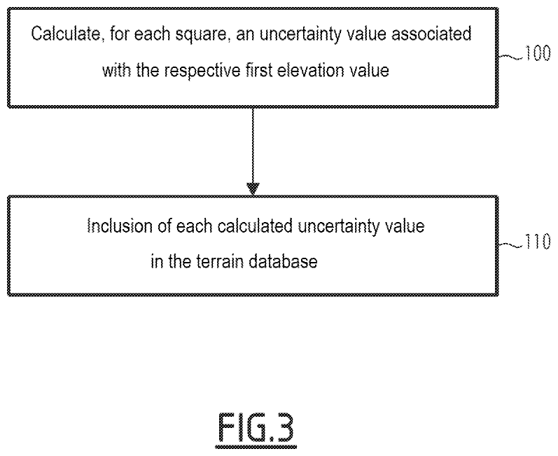

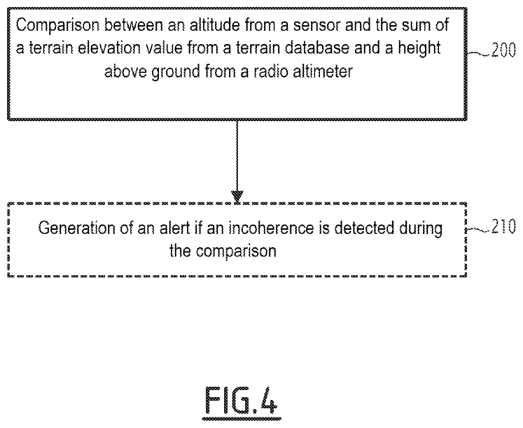

The operation of the invention will now be described with reference to FIG. 3 representing a flowchart of the method, according to the invention, of generating the first terrain database 15 intended to be stored in the storage device 10, then with reference to FIG. 4 representing a flowchart of the method, according to the invention, of monitoring the altitude of the aircraft 5, the method being implemented by the electronic monitoring device 40.

During an initial step 100, at least one uncertainty value δ_{BD1}, δ_{BD2} associated with the respective first elevation value 30 is calculated for each first mesh 28 of the first database 15, at least one δ_{BD1} of the calculated uncertainty values being calculated from the plurality of second elevation values 38 corresponding to said first mesh 28 and taken from the second terrain database 35.

During this step 100, the first uncertainty value δ_{BD1} is, for example, calculated for each first mesh 28 in the first database 15. Each first uncertainty value δ_{BD1} is preferably calculated from the plurality of second elevation values 32 corresponding to the respective first mesh 28.

Each first uncertainty value δ_{BD1} that is calculated from the plurality of second elevation values 32 is typically equal to the difference between the maximum value and the minimum value from among the plurality of second elevation values 32 associated with the respective first mesh 28, or alternatively the standard deviation of the second elevation values 32 associated with the respective first mesh 28 relative to said maximum value.

During this step 100, additionally or alternatively, the second uncertainty value δ_{BD2} is calculated for each respective first mesh 28. Each second uncertainty value δ_{BD2} preferably depends only on the data contained in the second database 35. Each second uncertainty value δ_{BD2} is typically calculated from the plurality of elevation deviations, each associated with a respective second mesh 38. Each second uncertainty value δ_{BD2} is for example equal, for a respective first mesh 28, to the maximum value from among the plurality of elevation deviations for the different second meshes 38 corresponding to said first mesh 28. Each second uncertainty value δ_{BD2} is preferably increased by the predefined constant, typically depending on the second resolution R2.

During the next step 110, each calculated uncertainty value δ_{BD1}, δ_{BD2} is then included in the first terrain database 15 intended to be stored in the storage device 10 and then to be carried inside the aircraft 5.

During the flight of the aircraft 5, the monitoring device 40 then compares, via its comparison module 50 and during an initial step 200 of the monitoring method, the altitude ALT_{MSL} from the altitude sensor 22 with the sum of the first terrain elevation value 30 from the first terrain database 15 and the height above ground H_{RA} from the radio altimeter 24.

During step 200, the comparison is carried out according to equation (1) or even according to equation (2), for example. The comparison module 50 then typically detects an absence of error concerning the altitude of the aircraft 5 if the inequation (3) is satisfied, and conversely the presence of an error concerning the altitude of the aircraft 5 if the inequation (4) is satisfied.

At the end of the comparison step 200, the monitoring device 40 proceeds to the next optional step 210, during which the generation module 52 generates an alert if the presence of an error is detected in the previous step 200. Additionally, the generated alert is the alert concerning the terrain database 15, or the alert concerning the altitude sensor 22, or the alert concerning the radio altimeter 24, or the alert concerning the altitude sensor 22 and the radio altimeter 24, or even the global alert, depending on the previously detected error, as previously described.

Thus, with the storage device 10 according to the invention, the first terrain database 15 intended to be carried on board the aircraft 5, further comprises for each first elevation value 30, at least one uncertainty value δ_{BD1}, δ_{BD2} associated with the respective elevation value 30, the uncertainty value δ_{BD1}, δ_{BD2} then allowing to better know the reliability of this elevation value 30.

In addition, at least one first uncertainty value δ_{BD1} is calculated from the plurality of second elevation values 32 from the second higher resolution R2 database 35, thereby allowing to have an even more reliable calculated uncertainty value.

The monitoring device 40 according to the invention then allows for more accurate monitoring of the altitude of the aircraft 5 by then comparing the altitude ALT_{MSL} from the altitude sensor 22 with the sum of the first elevation value 30 and the height above ground H_{RA} from the radio altimeter 24, furthermore taking into account the or the uncertainty value(s) δ_{BD1}, δ_{BD2} associated with the respective first elevation value 30 and included in the first terrain data base 15.

It is thus conceived that the electronic storage device 10 according to the invention provides a more reliable terrain database 15, and thus reduces risks of accidents of the aircraft 5.

1. An electronic storage device for storing a terrain database for an avionics system, the storage device being configured to be carried on board an aircraft, the terrain database corresponding to a terrain zone likely to be overflown by the aircraft, represented in the form of a surface divided into meshes, each mesh corresponding to a sector of the terrain zone, the terrain database having a first resolution and comprising first terrain elevation values, each being associated with a respective mesh,
wherein the terrain database further comprises, for each mesh, an uncertainty value associated with the respective first elevation value, at least one uncertainty value being calculated from a plurality of second terrain elevation values associated with said mesh and from a second terrain database having a second resolution, the second resolution being higher than the first resolution.

2. The electronic storage device according to claim 1, wherein the second terrain database is stored in an electronic equipment external to the electronic storage device.

3. The electronic storage device according to claim 1, wherein the at least one uncertainty value is selected for each mesh from among the group consisting of a difference between a maximum value and a minimum value from among the plurality of second elevation values associated with the respective mesh; and a standard deviation of the second elevation values associated with the respective mesh relative to said maximum value.

4. The electronic storage device according to claim 1, wherein at least one first elevation value is determined from the plurality of second elevation values associated with the respective mesh.

5. The electronic storage device according to claim 1, wherein the first and second resolutions are expressed in arc-second(s), the arc-second value of each resolution defining the dimension corresponding to a side of a smallest element representative of the terrain, a higher resolution then corresponding to a lower arc-second value.

6. An avionics system configured to be carried on board an aircraft, the avionics system comprising or being connected to an electronic device for storing a terrain database,
wherein the electronic storage device is according to claim 1, and
wherein the avionics system comprises an electronic monitoring device configured to monitor an altitude of the aircraft via a comparison between an altitude from an altitude sensor and the sum of a first terrain elevation value from the terrain database and a height above ground from a radio altimeter, the comparison depending on the uncertainty value associated with the respective first elevation value.

7. A generating method for generating a terrain database for an avionics system, intended to be stored in an electronic storage device configured to be carried on board an aircraft, the terrain database corresponding to a terrain zone likely to be overflown by the aircraft represented in the form of a surface divided into meshes, each mesh corresponding to a sector of the terrain zone, the terrain database having a first resolution and comprising first terrain elevation values, each being associated with a respective mesh,
the method being computer-implemented and comprising:
calculating, for each mesh, an uncertainty value associated with the respective first elevation value, at least one uncertainty value being calculated from a plurality of second terrain elevation values associated with said mesh and taken from a second terrain database having a second resolution, the second resolution being higher than the first resolution; and
including each calculated uncertainty value in the terrain database.

8. A non-transitory computer-readable medium including a computer program including the software instructions that, when executed by a computer, implement a generating method according to claim 7.

9. A monitoring method for monitoring a vertical positioning of an aircraft, the method being implemented by an electronic monitoring device configured to be carried on board the aircraft and connected to an electronic device for storing a terrain database,
the method comprising the comparison between an altitude from an altitude sensor and the sum of a first terrain elevation value from the terrain database and a height above ground from a radio altimeter, the comparison depending on the uncertainty value associated with the respective first elevation value, the terrain database having been generated via a generating method according to claim 7.

10. The monitoring method according to claim 9, wherein the method further comprises generating an alert in the case of determination of an error in said comparison, the generated alert being a function of the determined error and being selected from among the group consisting of: an alert concerning the terrain database, an alert concerning the elevation sensor, an alert concerning the radio altimeter, an alert concerning both the elevation sensor and the radio altimeter, and a global alert.

11. A non-transitory computer-readable medium including a computer program including software instructions which, when executed by a computer, implement a monitoring method according to claim 9.

12. The electronic storage device according to claim 2, wherein the external equipment is arranged outside the aircraft.

13. The electronic storage device according to claim 3, wherein each uncertainty value is calculated from said plurality of second elevation values associated with the respective mesh.

14. The electronic storage device according to claim 4, wherein at least one first elevation value is selected from among the group consisting of: a maximum value of the second elevation values associated with the respective mesh; a mean value of the second elevation values associated with the respective mesh; and the maximum value of the second elevation values minus N times a standard deviation of the second elevation values associated with the respective mesh from said maximum value, N being an integer greater than or equal to 1.

15. The electronic storage device according to claim 4, wherein each first elevation value is further determined from the second elevation values associated with the respective mesh.

16. The electronic storage device according to claim 5, wherein the first resolution is equal to 3 or 6 arc-seconds.

17. The electronic storage device according to claim 5, wherein the second resolution is equal to 1 or 2 arc-seconds.
